(19) United States
(12) Patent Application Publication
(10) Pub. No.: US 2024/0244488 A1
(43) Pub. Date: Jul. 18, 2024

(54) Service Tool for Predicting Quality of Service (QoS) of Wireless Networks

(71) Applicant: Saffron, LLC, Bothell, WA (US)

(72) Inventors: Srinivasan Jagannathan, Bothell, WA (US); Avinash Taware, Bothell, WA (US)

(21) Appl. No.: 18/410,998

(22) Filed: Jan. 11, 2024

Related U.S. Application Data
(60) Provisional application No. 63/479,609, filed on Jan. 12, 2023.

(51) Int. Cl. H04W 28/24; H04W 28/02

(52) U.S. Cl. CPC H04W 28/24; H04W 28/0226; H04W 28/0268

(57) ABSTRACT

A service tool utilizes a machine learning approach to generate predictions for Quality-of-Service (QoS) parameters at one or more locations within a wireless network. A hybrid machine learning model includes a physics-based model that models wireless signal propagation of the wireless assets in view of detected geospatial features in a region around the wireless assets, and includes a data driven model learned from historical measured operational data associated with the wireless network. A user interface enables a user to enter a location of interest and configure various settings associated with generating the QoS predictions. Prediction results may be presented in a map overlay. The user interface may furthermore be used to resolve issues of subscribed wireless service of existing customers or present recommendations for subscribing to a wireless service based on the QoS predictions, and may directly facilitate enrollment of new customers.

### CROSS-REFERENCE TO RELATED APPLICATIONS

This application claims the benefit of U.S. Provisional Patent Application No. 63/479,609 filed on Jan. 12, 2023, which is incorporated by reference herein.

### BACKGROUND

The rapid evolution of wireless communication technologies has spurred an unprecedented surge in the demand for high-quality and reliable connectivity. However, the ever-increasing user expectations for seamless connectivity, low latency, and high throughput pose significant challenges for existing wireless communication systems. Understanding what quality of service (QoS) a user can expect at a particular physical location is therefore highly valuable information for both customers and wireless service providers. However, QoS of a wireless network may be affected by many factors including distance from the access point, obstacles or other interference, network congestion, communication protocol employed, security measures, network configuration, and/or devices involved. Thus, predicting QoS for different physical locations of wireless network receivers accurately remains a significant challenge.

### SUMMARY

A computer-implemented method predicts one or more Quality of Service (QoS) parameters associated with a wireless network. A target location for predicting the one or more QoS parameters is obtained. Characteristics are determined for one or more wireless assets in a region associated with the target location. Geospatial features are also obtained for the region associated with the target location. A hybrid machine learning model is applied to predict the one or more QoS parameters at the target location based on the characteristics of the one or more wireless assets and the geospatial features for the region. The hybrid machine learning model is based in part on a physics-based model that models wireless signal propagation of the wireless assets given the geospatial features, and the hybrid machine learning model is furthermore based in part on a data driven model learned from historical measured operational data associated with the wireless network. The one or more QoS parameters are outputted to a user interface.

In an example embodiment, the target location may be obtained via a user interface based on receiving a set of geospatial coordinates, a street address, or a selected position in a map view.

In an example embodiment, the geospatial features are obtained by obtaining satellite map image data from a map data source, and processing the satellite map image data to identify one or more obstacles in the region that impact wireless signal propagation. In an example embodiment, processing the satellite map image data comprises applying a machine learning model trained to identify and characterize the obstacles.

In an example embodiment, the one or more obstacles may comprise at least one of: a building, a tree, foliage, a manmade structure, and a geological feature.

In an example embodiment, a selection may be received to perform a broad area analysis. Responsive to the selection to perform a broad area analysis, the QoS parameters may be predicted over a broad prediction region including the target location at a first spatial resolution. Alternatively, a selection may be received to perform a focused area analysis. Responsive to the selection to perform a focused area analysis, the QoS parameters may be predicted over a focused prediction region including the target location at a second spatial resolution higher than the first spatial resolution. In an example embodiment, the focused prediction region corresponds to a single property of an existing customer or prospective customer of the wireless network.

In an example embodiment, the region associated with the target location comprises a Fresnel zone representing an area around a line-of-sight of a receiver at the target location.

In an example embodiment, outputting the one or more QoS parameters comprises generating a map overlay that represents different values of the one or more QoS parameters at different locations using a color-coding scheme.

In an example embodiment, the method further comprises generating a recommended subscription service associated with the wireless network dependent on the one or more QoS parameters predicted for the target location, presenting the recommended subscription service in the user interface, and facilitating enrollment of an existing or prospective customer in the recommended subscription service.

In an example embodiment, the method further comprises performing a comparison of the one or more QoS parameters predicted for the target location to measured QoS parameters experienced by an existing customer, identifying a subscriber service issue based on the comparison, and facilitating resolution of the subscriber service issue for that customer.

In an example embodiment, the one or more QoS parameters comprises at least one of: RSRP, SINR, download (D/L) speed, upload (U/L) speed.

In further embodiments, a non-transitory computer-readable storage medium stores instructions executable by one or more processors for carrying out any of the methods described herein. In yet further embodiments, a computer system includes one or more processors and a non-transitory computer-readable storage medium that stores instructions for carrying out any of the methods described herein.

### BRIEF DESCRIPTION OF THE DRAWINGS

FIG. 1 is an example embodiment of a computing environment associated with predicting QoS parameters for a wireless network.

FIG. 2 is a first example embodiment of a user interface for presenting predicted QoS parameters based on a broad area analysis.

FIG. 3 is a second example embodiment of a user interface for presenting predicted QoS parameters based on a focused area analysis.

FIG. 4 is a block diagram illustrating an example embodiment of a backend server for predicting QoS parameters for a wireless network.

FIG. 5 is a block diagram illustrating an example embodiment of a machine learning (ML) training module for training one or more hybrid ML models for predicting QoS parameters for a wireless network.

FIG. 6 is a block diagram illustrating an example embodiment of an ML inference module for predicting QoS parameters for a wireless network based on one or more hybrid ML models.

FIG. 7 is a flowchart illustrating an example embodiment of a process for training one or more ML models for predicting QoS parameters for a wireless network.

FIG. 8 is a flowchart illustrating an example embodiment of a process for predicting QoS parameters for a wireless network based on one or more ML models.

FIG. 9 is a flowchart illustrating an example embodiment of a process for facilitating customer enrollment in a wireless network service based on predicted QoS parameters.

FIG. 10 is a flowchart illustrating an example embodiment of a process for providing customer service to a customer of a wireless network service based on predicted QoS parameters.

### DETAILED DESCRIPTION

A service tool utilizes a machine learning approach to generate predictions for Quality-of-Service (QoS) parameters at one or more locations within a wireless network. A hybrid machine learning model includes a physics-based model that models wireless signal propagation of the wireless assets in view of detected geospatial features in a region around the wireless assets, and includes a data driven model learned from historical measured operational data associated with the wireless network. A user interface enables a user to enter a location of interest and configure various settings associated with generating the QoS predictions. Prediction results may be presented in a map overlay. The user interface may furthermore be used to resolve issues of subscribed wireless service of existing customers or present recommendations for subscribing to a wireless service based on the QoS predictions, and may directly facilitate enrollment of new customers.

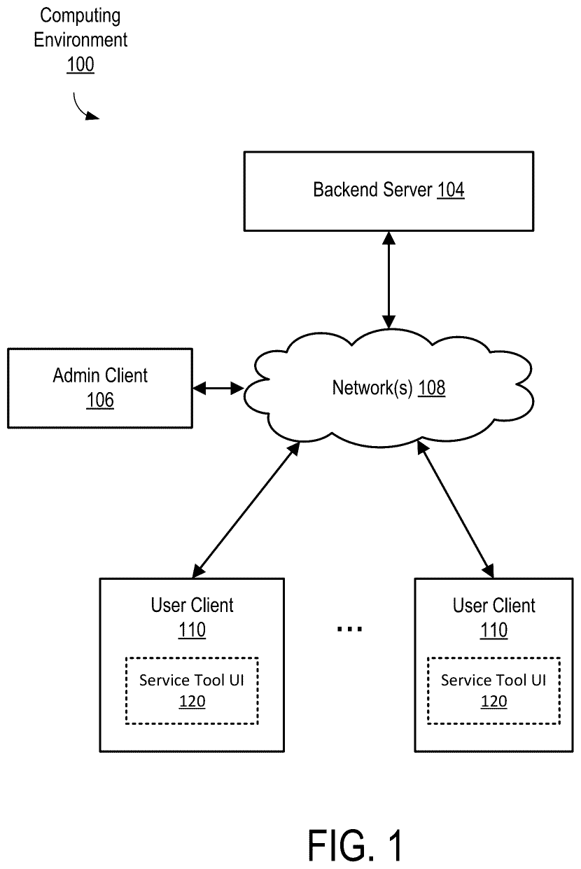

FIG. 1 illustrates an example embodiment of a computing environment 100 associated with a service tool for predicting QoS parameters associated with wireless service. The computing environment 100 may include a backend server 104, an administrative client 106, and one or more user clients 110 coupled by a network 108. Alternative embodiments may include different or additional components.

The user client 110 comprises a computing device capable of interacting with the backend server 104 via the network 108. The user client 110 may access a service tool user interface (UI) 120 that may execute locally as an application installed on the user client 110 or may comprise a web-based application accessible via web browser. The service tool UI 120 of the user client 110 may enable various data entry for communicating to the backend server 104, transfer of data to the backend server 104, and viewing and/or interaction with various information obtained from the backend server 104 or directly inputted to the service tool UI 120. In various embodiments, the user client 110 may be embodied, for example, as a mobile phone, a tablet, a laptop computer, a desktop computer, a gaming console, a head-mounted display device, or other computing device.

In an embodiment, the service tool UI 120 may comprise various functions for generating reports about quality of wireless and Fixed-Wireless Access (FWA) service at a given physical location. For example, the service tool UI 120 may enable selection of a location specified by geographical coordinates (latitude and longitude) or street address and may present various information relating to assessed and/or predicted QoS of a wireless network at that location. Additionally, the service tool UI 120 may depict predicted QoS parameters for receivers over a user-defined region (e.g., as an overlay in a map view). The QoS information may include parameters such as Reference Signal Received Power (RSRP), Reference Signal Received Quality (RSRQ), receive signal strength indicator (RSSI), Signal to Interference plus Noise Ratio (SINR), and/or network experience parameters such as download (D/L) and upload speed (U/L). The service tool UI 120 may be used by existing customers of a wireless service provider, prospective customers of a service provider, or by sales and marketing professionals of a wireless service provider including traditional wireless or FWA service.

The backend server 104 performs various functions for generating user interfaces, processing user inputs, and performing various analytics. The backend server 104 may furthermore execute one or more ML algorithms for training ML models and/or generating inferences based on various trained ML models as further described herein. For example, the backend server 104 may continuously tune (re-train) and improve one or more ML models for accurately predicting QoS at a particular geographic location. In an example embodiment, the ML model may include a hybrid ML model that incorporates both theoretical physics-based wave propagation models as well as data driven ML models that use QoS measurements, wireless asset data, and geospatial data to accurately predict QoS for real or theoretical receivers at different physical locations.

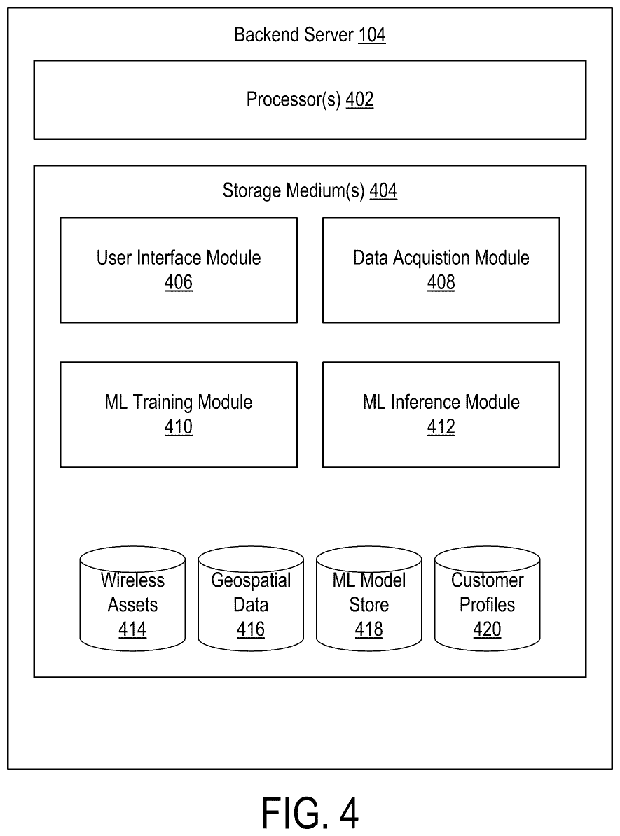

The backend server 104 may be implemented using cloud processing and storage technologies, on-site processing and storage systems, virtual machines, other technologies, or a combination thereof. For example, in a cloud-based implementation, the backend server 104 may include multiple distributed computing and storage devices managed by a cloud service provider. The various functions attributed to the backend server 104 are not necessarily unitarily operated and managed, and may comprise an aggregation of multiple servers responsible for different functions of the backend server 104 described herein. In this case, the multiple servers may be managed and/or operated by different entities. In various implementations, the backend server 104 may comprise one or more processors and one or more non-transitory computer-readable storage mediums that store instructions executable by the one or more processors for carrying out the functions attributed to the backend server 104 herein. An example embodiment of a backend server 104 is illustrated in FIG. 4 and described in further detail below.

The administrative client 106 comprises a computing device for facilitating administrative functions associated with operation of the backend server 104. For example, the administrative client 106 may comprise a user interface for performing functions such as configuring parameters associated with various ML algorithms, initiating deployment of software updates to the user clients 110, etc. The user interface of the administrative client 106 may be embodied as an application installed on the administrative client 106 or may comprise a web-based application accessible via web browser.

The one or more networks 108 provides communication pathways between the backend server 104, the administrative client 106, and/or the user clients 110. The network(s) 108 may include one or more local area networks (LANs) and/or one or more wide area networks (WANs) including the Internet. Connections via the one or more networks 108 may involve one or more wireless communication technologies such as satellite, WiFi, Bluetooth, or cellular connections, and/or one or more wired communication technologies such as Ethernet, universal serial bus (USB), etc. The one or more networks 108 may furthermore be implemented using various network devices that facilitate such connections such as routers, switches, modems, firewalls, or other network architecture.

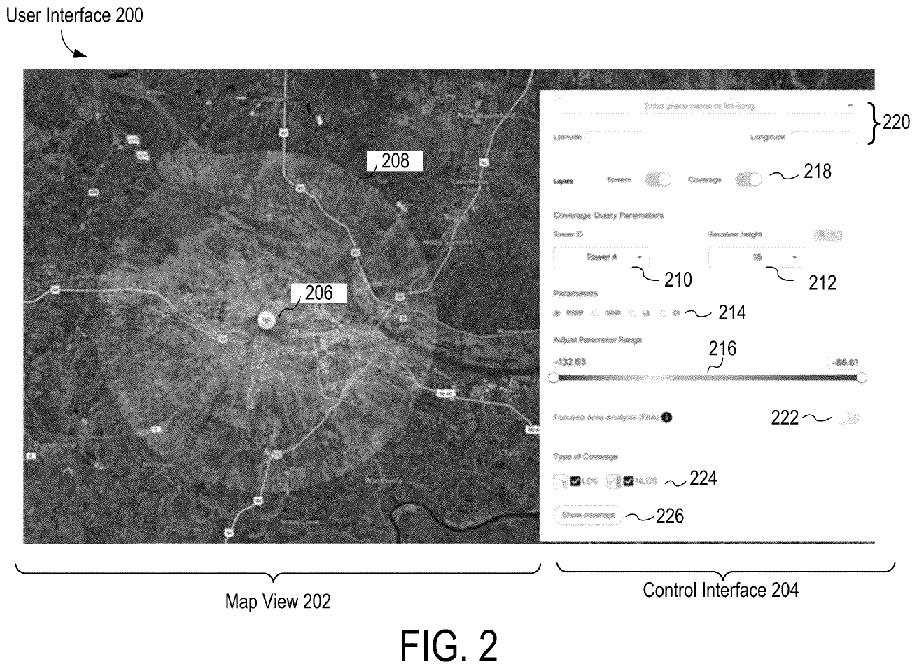

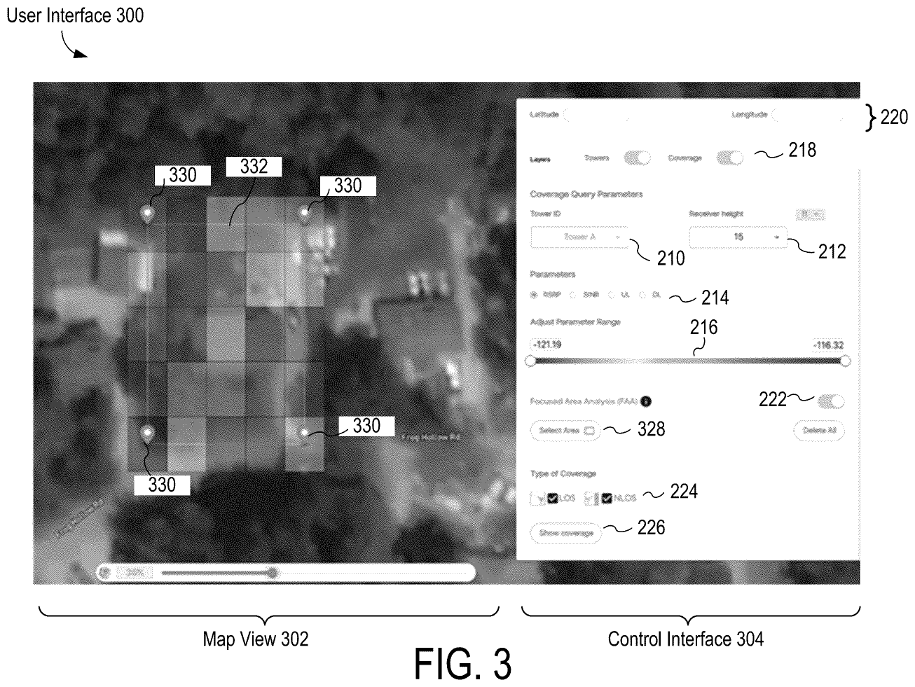

FIG. 2 is an example embodiment of a user interface 200 associated with the service tool UI 120 described above. The user interface 200 includes a map view 202 and a control interface 204. The map view 202 shows a location of a tower 206 and a coverage map 208 around the tower 206. The coverage map 208 visually indicates predicted QoS parameters at different locations within the coverage map 208. Different values of the predicted QoS parameters for different locations may be depicted using color coding or other visual indicators. The control interface 204 includes various controls for controlling the information shown in the map view 202. Location controls 220 allow a user to enter a specific location (e.g., by landmark name, street address, coordinates (e.g., latitude and longitude), or other data inputs) for depicting in the map view 202. Alternatively, a user may scroll directly in the map view 202 to change the area selection. The control interface 204 furthermore includes layer controls 218 for controlling which layers are depicted in the map view 202. For example, the layer controls 218 may include toggle switches for displaying or hiding a layer depicting towers and/or a layer depicting the respective coverage maps 208. The control interface 204 may include various coverage query parameter input controls such as a tower selection control 210 for selecting a specific tower and a receiver height control 212 for configuring the height of theoretical or known actual installed receivers for which QoS parameters may be predicted. Changing the receiver height 212 may affect the QoS predictions and a different pattern may therefore be depicted in the map view 202 depending on the selected receiver height 212. Parameter selection controls 214 control what type of QoS parameter is modeled and depicted. For example, the parameter selection controls 214 may enable selection between RSRP, SINR, U/L, D/L, or other types of QoS parameters. The parameter range control 216 defines a parameter range (which may have a configurable lower bound and upper bound) for defining the extent of the coverage map 208. Locations outside the range are not depicted in the coverage map 208. For example, in the illustrated example, the coverage map 208 shows areas with predicted RSRP parameter values between −132.63 and −86.61 decibels (dB) (with respect to “Tower A” and for receivers at a height of 15 feet above ground in the area of prediction). The RSRP parameter value is the strength of the predicted signal measured in decibels (dB). The focused area analysis (FAA) control 222 enables switching between a broad coverage view for a relatively wide geographic region (as shown in the map view 202 of FIG. 2) and a higher resolution localized coverage view described in further detail below with respect to FIG. 3. The coverage type controls 224 control which coverage types are used for the QoS predictions and displayed in the map view 202 (e.g., line-of-sight (LOS) only, non-line-of-sight (NLOS), or both). A show coverage button 226 causes the map view 202 to update and regenerate predictions based on the currently selected configuration.

FIG. 3 illustrates an example embodiment of a user interface 300 for the service tool UI 120 when the focused area analysis 222 control is toggled on. When selected, the service tool UI 120 limits the QoS parameter predictions to a user selected relatively smaller localized area (compared to the broad area analysis of FIG. 2) such as property of a particular existing customer or prospective customer of a wireless service provider. A select area control 328 enables a user to finely draw out the selected area for analysis. For example, selection may be made by positioning corner points 330 directly in the map view 302. Within the localized area 332, the map view 302 may depict a color-coded grid that shows predicted QoS parameter values for each sub-region within the grid. The height adjustment control 212 may furthermore be used to change the receiver height applied in the predictions, and the predicted QoS values for the localized area may be updated accordingly. The focused area analysis 222 may be useful to identify a specific location (position and height) for receiver placement at a particular property that is predicted to achieve the best QoS.

Relative to the broad coverage analysis view depicted in FIG. 2, the focused area analysis view generates predicted QoS parameters in a much smaller region but may do so at higher resolution than in the broad coverage analysis. This typically will increase the accuracy of the prediction for that selected region/area. In contrast, the broad coverage analysis depicted in FIG. 2 may be computed in relatively lower resolution to reduce computational complexity and latency associated with calculations for each individual location in the coverage map 208. For example, the broad coverage analysis view may perform QoS predictions at a resolution of one prediction per square mile, while the focused area analysis view may compute predictions at a resolution of one prediction per 10 square feet.

FIG. 4 is a block diagram illustrating an example embodiment of a backend server 104. The backend server 104 includes one or more processors 402 and one or more storage mediums 404. The one or more storage mediums 404 includes various functional modules (implemented as instructions executable by the one or more processors 402) including a user interface module 406, a data acquisition module 408, an ML training module 410, an ML inference module 412, a wireless asset data store 414, a geospatial data store 416, an ML model data store 418, and a customer profile data store 420. In alternative embodiments, the backend server 104 may include different or additional modules. The one or more processors 402 and one or more storage mediums 404 are not necessarily co-located and may be distributed (e.g., in a cloud architecture). Furthermore, various modules may interact with external (e.g., third-party services) via an application programming interface (API). For example, the data acquisition module 408 may communicate with location services, map services, or other services to obtain data described herein. Furthermore, the various data stores 414, 416, 418, 420 may include cloud storage and/or databases that are managed by third-party entities that may be separate from an entity managing the various modules 406, 408, 410, 412.

The user interface module 406 facilitates server-side functions of a user interface accessible on the user clients 110. The user interface module 406 may generally enable various functions associated with predicting and/or presenting information about wireless QoS at different physical locations. For example, the user interface may enable a user to input a geographic location and obtain observed or predicted QoS information associated with the location and/or surrounding region. Inputs may be received through various control interfaces (such as control interfaces 204, 304) and may include various control elements such as text boxes, check boxes, drop-down menus, toggle buttons, multi-select boxes, or other menu controls. In some embodiments, the input data may be obtained interactively by presenting a series of questions via the user interface that enable structured input of data required to predict QoS. Questions may be presented for various input forms such as multiple choice, true/false, or text-based inputs. The user interface may utilize various input elements such as radio buttons, drop-down lists, multi-select checkboxes, or freeform text boxes. In further embodiments, inputs may be entered via a natural language chatbot. In other embodiments, the input data may be imported from another data source and is not necessarily inputted via the user interface module 406 of the user client 110.

The user interface module 406 may furthermore present information in a geospatial map interface such as the map views 202, 302 described above. Here, a geospatial map may include an overlay showing locations of one or more different types of wireless assets (e.g., antennas, towers on which the antennas are mounted) deployed in a region or that are planned to be deployed in the region, geospatial features of the depicted region (e.g., locations of buildings, trees, or other obstacles that impact wireless transmission), and information about measured and/or predicted QoS at different locations. The geospatial map may be searchable by input of geographic coordinates (e.g., latitude, longitude), a street address, and/or using pointer-based control elements such as clicking on a specific location, scrolling to a region, or zooming to a specific region.

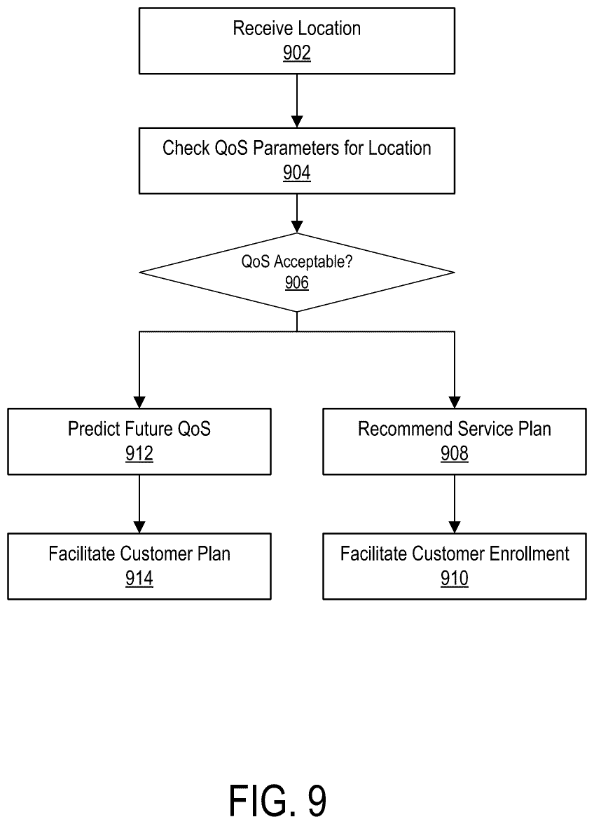

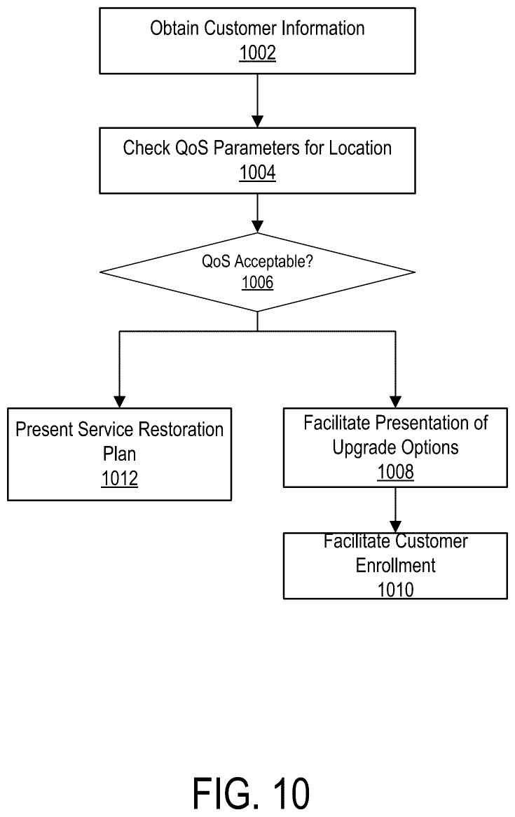

The user interface module 406 may furthermore enable users to access or directly interact with a sales and/or customer support module associated with a wireless service provider. For example, the user interface module 406 may enable a user to view QoS information for a location and then directly establish a wireless service plan if the QoS is acceptable. Here, the user interface module 406 may optionally recommend a particular service plan and/or allow the user to choose between different service options depending upon the different levels of QoS associated with those options. For example, a potential new customer can use the service tool UI 120 in a self-guided fashion to check if wireless service with acceptable QoS is available at their physical address and sign up for the service. If the service is not available or QoS of the current service is not acceptable, the potential customer can use the service tool UI 120 to check if the service with acceptable QoS will be available in future based on wireless assets planned for deployment by the provider. The user interface may present prompts for the user to enter the various inputs, provide those inputs to a server for processing (together with other stored data from a data store), and generate outputs presented in the user interface that collectively facilitate the described process. In a further embodiment, a user may input multiple locations and obtain information comparing the respective QoS parameters at the different locations. The user interface module 406 may furthermore allow existing customers or support staff (e.g., after sales service team) for a wireless service provider to input observations about QoS at a specific location. For example, a customer may report diminished service. Examples of these features are described further below with respect to FIGS. 9-10.

The user interface module 406 may furthermore include tools for entering and/or viewing customer information such as customer name, address, contact information, preferences, devices owned, subscription plans, etc. The customer information may be stored to the customer profile data store 420.

Although the user interface module 406 is illustrated as a component of the backend server 104 in FIG. 4, all or a subset of the functions of the user interface module 406 may instead be executed on the user client 110. For example, the user client 110 may download an application from the backend server 104 that includes all or some of the functions of the user interface module 406. The user client 110 may locally execute instructions associated with these functions.

The data acquisition module 408 acquires various data that may be utilized to train ML models and predict QoS parameters associated with one or more locations. The data acquisition module 408 may obtain various types of information including wireless asset information, geospatial information, and observed QoS information. The wireless asset information may include information about deployed wireless assets such as, for each asset, a type of asset (e.g., antenna, transmitter, receiver, repeater, etc.), a location of the asset (e.g., latitude, longitude, elevation), operational parameters associated with the asset (e.g., transmit strength, receive strength, communication protocol, power requirements, propagation pattern, etc.), age of the asset, maintenance history, or other information. The geospatial information may include information about various obstacles, interference sources, or other geospatial features in the vicinity of the wireless asset that may affect QoS. Examples of geospatial information may include locations and/or characteristics of buildings, locations and/or characteristics of trees or other foliage, locations and/or characteristics of other man-made structures such as bridges, roads, lighting systems, towers, etc., natural geographic features such as hills, mountains, valleys, lakes, etc., population-based features such as total population, population density, demographics, etc. Examples of observed QoS information may include RSRP, RSRQ, RSSI, SINR, D/L, U/L, or other applicable QoS parameters. The QoS parameters may furthermore include various aggregate parameters that combine one or more individual parameters such as those described above. The wireless asset data may be stored to the wireless asset data store 414 and the geospatial data may be stored to the geospatial data store 416.

The data acquisition module 408 may obtain data from various sources such as map data services, location data services, wireless asset database services, or other data sources. For example, the data acquisition module 408 may obtain data backend data associated with existing customers of wireless (including FWA) service providers. The data may include information about receiver locations for each customer (position and height) and observed QoS parameters for each receiver in association with communications from a base station. The data acquisition module 408 may also obtain observed/measured QoS data associated with different receiver locations from drive-tests that may be carried out periodically by service providers in different service areas (without necessarily relating to existing customers). The data acquisition module 408 may furthermore obtain observed QoS data from various open source and/or crowdsourced data sources (e.g., OOKLA). The data acquisition module 408 may obtain geospatial data from one or more Geographical Information System (GIS) databases. This data may include maps with information about terrain, buildings, foliage, etc. For example, terrain data may be obtained from U.S. Geological Survey (USGS) maps/databases. Map data with satellite images may also be obtained from various map services and/or government managed databases. Satellite image data may be processed using various image processing techniques to identify locations of buildings, foliage, or other obstacles that may affect wireless signal propagation, as will be described further below.

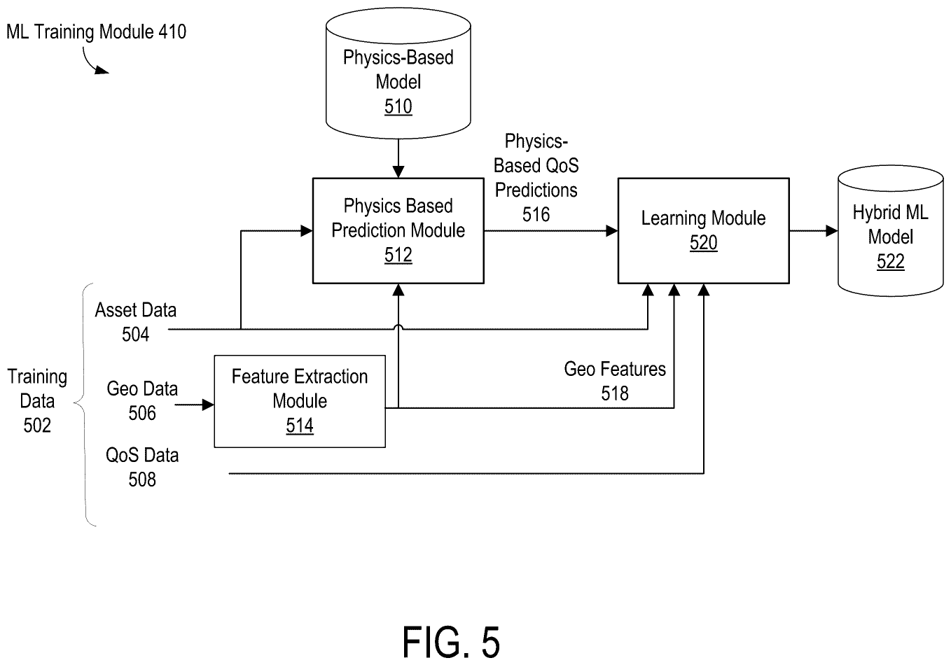

The ML training module 410 trains one or more ML models for predicting wireless QoS. The ML training module 410 may apply a supervised ML algorithm to a training dataset to learn a set of model parameters (e.g., weights) for predicting QoS at a given location. Predictions may be expressed as a value for one or more QoS parameters and may include a confidence interval indicating a strength of the prediction. In example implementation, the ML training module 410 may employ ML techniques such as logistic regression, random forest, neural networks (such as recurrent neural networks (RNNs), convolutional neural networks (CNNs), etc.), gradient boosting (e.g., XGBoost, GBM, etc.), decision tree regressors, support vector machine (SVM) regressors, stacked ensemble models. In an embodiment, the ML training module 410 may periodically retrain the one more ML model as additional training data becomes available. An example embodiment of the ML training module 410 trains one or more hybrid ML models that incorporate aspects of both physics-based wave propagation models and data driven statistical models. An example embodiment of an ML training module 410 for training hybrid ML models is described in further detail below with respect to FIG. 5. The ML training module 410 may train separate models to estimate different QoS parameters. Furthermore, the ML training module 410 may generate separate ML models for different geographic regions. Alternatively, the ML training module 410 may jointly train a single model that jointly predicts multiple QoS parameters.

The model store 418 stores the one or more hybrid ML models generated by the ML training module 410.

The ML inference module 412 applies the one or more trained ML models from the ML model store 418 to an input feature set to generate predicted QoS parameters. The input feature set may include a location (or range of locations within a defined region) and derived information associated with the location such as characteristics of deployed (or planned) wireless assets and geospatial features in the vicinity of the location. The ML inference module 412 may select an appropriate ML model from the ML model store dependent on the QoS parameters for prediction, the geographic region associated with the prediction, or other factors.

If a trained ML model is not available in the ML model store 418 for a selected region, the ML inference module 412 may apply an ML model associated with a similar region. Various criteria such as geospatial features, type of wireless assets, and location of users are used to determine the similarity between the region of interest and region for which trained ML model is available. In some embodiments, a weighted combination of two or more ML trained models stored in ML model store 418 can be used to predict QoS parameters for such a region of interest if there are multiple similar regions.

In one embodiment, the ML inference module 412 may furthermore generate QoS predictions for a geographic region at different selectable resolutions. For example, if the ML inference module 412 is configured to generate QoS predictions over a broad geographic area (such as in the interface 200 of FIG. 2), it may operate at a relatively lower resolution (e.g., generating one prediction per square mile). In another configuration, the ML inference module 412 may generate QoS predictions for a highly localized geographic region such as an individual residential or commercial property (e.g., the interface 300 of FIG. 3). Here, the ML inference module 412 may operate with a relatively higher resolution (e.g., one prediction per 10 sq. ft). In an embodiment, the resolution may be automatically selected depending on the size of the selected region for predictions. In other embodiments, the resolution may be expressly configurable by a user.

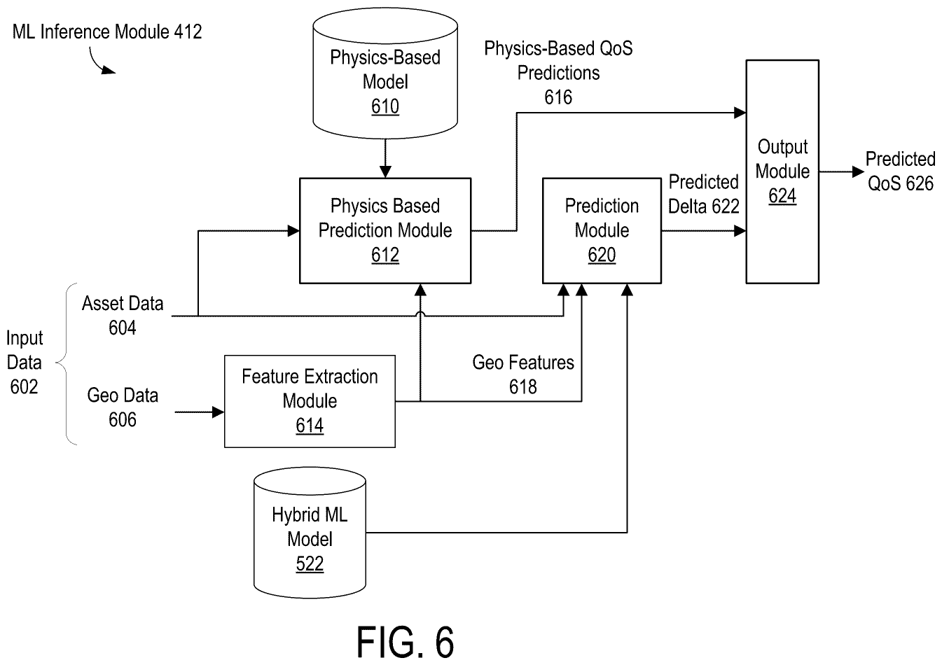

In an embodiment, the ML inference module 412 applies one or more hybrid ML models that incorporate aspects of both physics-based wave propagation models and data driven statistical models. An example embodiment of an ML inference module 412 that utilizes a hybrid ML model is described in further detail below with respect to FIG. 6.

While the ML inference module 412 is illustrated separately from the ML training module 410, an example implementation may involve these modules 410, 412 sharing various functions that are executed during both training and inference phases.

FIG. 5 is a block diagram illustrating an example embodiment of the ML training module 410. In this example, the ML training module 410 generates one or more hybrid ML models 522 that incorporate aspects of a physics-based model 510 and data-driven statistical learning techniques. The ML training module 410 obtains training data 502, which may include asset data 504 (describing types and locations of wireless assets such as base stations and receivers), geospatial data 506 (describing geospatial features in the areas around the wireless assets), and observed/measured QoS data 508 (describing observed QoS parameters for each of the receivers). The feature extraction module 514 may apply various image processing techniques to satellite image map data to identify geospatial features 518 such as foliage, buildings, or other visible obstacles that can affect wireless signal propagation. In an embodiment, the feature extraction module 514 may employ a separate ML model (such as a deep learning model using Convolutional Neural Networks (CNN)) trained to recognize features and their various characteristics (e.g., type of obstacle, size, shape, location, density, material characteristics, etc.). The feature extraction module 514 may then segment the map images and generate geospatial features representative of the detected obstacles. Alternatively, the feature extraction module 514 may directly obtain geospatial features from map metadata or other data sources.

The physics-based prediction module 512 applies a physics-based model 510 to the asset data 504 and extracted geospatial features 518, to generate, for each asset, physics-based QoS predictions 516 for expected QoS parameters. For example, the physics-based prediction module 512 may compute Fresnel zones for receivers at specified locations in relation to a base station tower, and may model wireless propagation paths between the transmitter and receivers. The Fresnel zones include a region within the visual LOS of a wireless asset in which the wireless waves spread out after they leave the antennas. The relevant Fresnel zone may be determined based on operational frequency, range, type of signal processing employed by the antenna such as Time Division Duplex (TDD) or Time Division Multiplexing (TDM), or other parameters of the respective wireless asset.

In some implementations, the physics-based model 510 may comprise a simple equation that models signal loss characteristics based only on distance of a receiver from a base station (e.g., RSRP˜log(1/distance of the receiver from the base station)). In other embodiments, the physics-based model 510 couple comprise a significantly more complex equation or set of equations that may incorporate various modeling parameters associated with non-ideal factors such as environmental conditions, interference, etc., which may be based on specific geospatial features 518 detected by the feature extraction module 514. For example, the physics-based model 510 may model how wireless signal propagation is affected by specific characteristics of the wireless assets (e.g., transmit/receive power, antenna size, propagation pattern, communication protocol, etc.) and by geospatial features 518 in the path of the wireless signals. In further embodiments, the physics-based model 510 may comprise an ML model that is trained to predict QoS parameters based on distance, transmitter characteristics, geospatial features in the signal path, or other physics-based factors. In other embodiments, the physics-based model 510 may be derived from simulations of wireless signal propagation under various conditions. In yet further embodiments, the physics-based prediction module 512 may be omitted from the ML training module 410 and the physics-based QoS predictions 516 may instead be obtained from an external data source. The general process applied by the ML training module 410 may be agnostic to the specific physics-based model 510 that is applied. Thus, for example, the same ML training module 410 could train different hybrid ML models 522 for different service providers based on different preferred physics-based models 510 or based on direct input of physics-based QoS predictions 516 that may be available from the service providers.

The learning module 520 applies a data driven ML algorithm to learn model parameters of a hybrid ML model 522 that predicts a delta (difference) between the physics-based QoS predictions 516 and the observed/measured QoS data 508 associated with respective wireless assets. For example, for each QoS parameter that is historically observed for a particular receiver at a particular location, the learning module 520 obtains a delta (difference) between the actual observed/measured QoS parameter value 508 and the QoS parameter value 516 predicted by the physics-based model 510 for the same receiver. Based on many such data points, the learning module 520 learns statistical correlations between the various inputs and the observed deltas. The learned hybrid ML model 522 can then predict the delta for a given location and based on a relevant set of geospatial features 518 and asset data 504 for that location. Here, the learning module 520 may utilize the computed Fresnel zones to limit the geospatial region and corresponding wireless asset data and geospatial features associated with each input location. The hybrid ML model 522 may thus characterize the effects of geospatial features 518 and/or various asset characteristics in a manner that may not be accounted for in the physics-based model 510 alone.

FIG. 6 illustrates an example embodiment of an ML inference module 412 that may generate predictions based on the trained hybrid ML model 522 described above. Here, the ML inference module 412 obtains input data which may include asset data 604 (describing the type and location of one or more wireless assets) and geospatial data 606 describing geospatial features in the areas around the one or more wireless assets. The feature extraction module 614 may extract geospatial features 618 from the geospatial data 606 in the same manner described above. Alternatively, the feature extraction module 614 may directly obtain geospatial features from map metadata or other data sources. The physics-based prediction module 612 applies the physics-based model 610 to the asset data 604 and geospatial features 618 to generate physics-based QoS predictions 616 for the QoS parameters (e.g., associated with a region such as a Fresnel zone around the target location) in the same manner described above. The prediction module 620 applies the trained hybrid ML model 522 to the input data 602 to generate a predicted delta 622 (representing a correction to the physics-based QoS predictions 616) based on the geospatial features 618 and/or particular characteristics of the wireless assets 604 (within a limited region such as the Fresnel zone associated with the target location). An output module 624 then modifies the physics-based QoS prediction 616 based on the predicted delta 622 to generate a predicted QoS 626. In one embodiment, this modification could comprise computing a sum of the physics-based QoS prediction 616 and predicted delta 622.

As described above, different hybrid ML models 522 may be generated for different geographic regions, different types of QoS parameters, or based on other variables. The ML inference module 412 may select and apply an appropriate ML model 522 dependent on the input data 602.

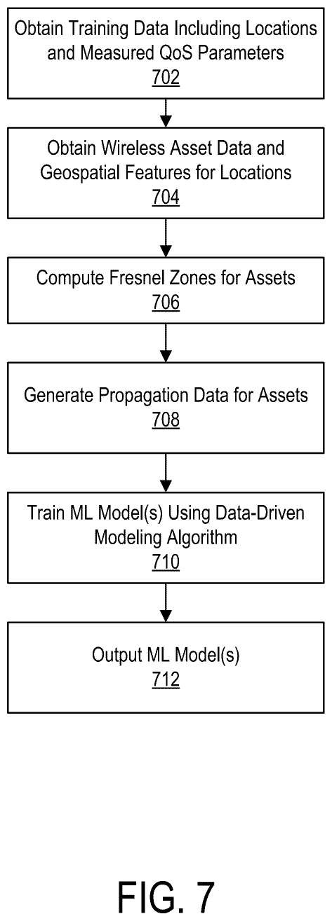

FIG. 7 illustrates an example embodiment of a process for training an ML model to generate QoS predictions. In an example embodiment, the training module may train a hybrid ML model that uses dataset(s) of measured QoS parameters to calculate QoS prediction error, which may then be applied to compensate for predicted error in the physic-based model.

In an example training process, the ML training module 410 obtains 702 a set of training data including locations, which may be specified by latitude, longitude, and altitude of receivers. Alternatively, locations may be specified based on street address. The ML training module 410 also obtains various QoS parameters observed/measured at each location. Furthermore, the ML training module 410 may obtain 704 wireless asset data describing receiver assets deployed at the locations and locations of relevant base stations and geospatial features associated with the locations. As described above, the geospatial features may be extracted from satellite image data using various ML and/or image processing techniques to identify and characterize obstacles that may affect signal propagation such as building, foliage, etc. The ML training module 410 may compute 706 Fresnel zones associated with different wireless assets to determine training data for each asset (i.e., a feature vector including the geospatial features and asset features within the Fresnel zone). The ML training module 410 may generate 708 wireless propagation data for each asset within the respective Fresnel zones (e.g., by applying a physics-based model as described above). The ML training module 410 trains 710 one or more ML models by applying a data-driven learning algorithm that models a mapping between the training data associated with each location and the measured QoS parameters for each location. As described above the algorithm may calculate QoS prediction error and train models to optimize suitable norms (e.g., L1, L2) of the prediction error. The ML training module 410 may output 712 the one or more trained ML models, which may be stored in the ML model store 418 for application by the ML inference module 412. In an embodiment, a set of multiple models may be trained that each relate to a different QoS parameter.

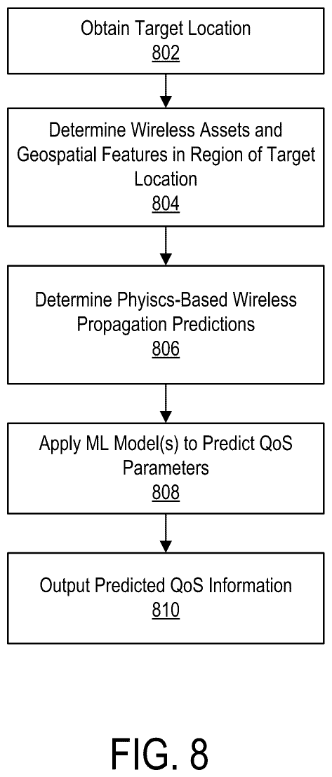

FIG. 8 illustrates an example embodiment of a process for inferring or predicting one or more QoS parameters for a wireless network. Predicted parameters may include metrics, such as, for example, RSRP, SINR, U/L, D/L, etc. at a given location. The ML inference module 412 obtains 802 a target location (or range of target locations for a region and given resolution). The location may comprise coordinates such as latitude, longitude, and elevation/altitude. The coordinates may be obtained directly (e.g., from a user input) or obtained from a location service based on an input street address. Based on the location, the ML inference module 412 determines 804 wireless assets and geospatial features in a relevant region (e.g., Fresnel zone) around the location. For example, the ML inference module 412 may perform a lookup in a network assets database to obtain information about deployed wireless assets such as antennas, access points, or other equipment. In further embodiments, the ML inference module 412 module may obtain information about wireless assets that are planned to be deployed in the future or about any theoretically placed receiver. The obtained information may include, for example, specific location of the wireless assets, type of equipment, configuration of the wireless assets, capabilities, performance characteristics, etc. As described above, geospatial features may be derived from satellite map images or from other data sources.

The ML inference module 412 determines 806 physics-based wireless propagation predictions associated with a receiver at the target location using a physics-based model based on the wireless asset data and/or geospatial features within the Fresnel zone. The ML inference module 412 module applies 808 one or more ML models to the wireless asset data, the geospatial features, and the physics-based prediction to infer or predict the one or more QoS parameters. In an embodiment, the ML inference module 412 may operate by predicting a delta associated with physic-based prediction of the QoS parameters, and then combining the delta with the physics-based prediction to generate the output QoS predictions. The ML inference module 412 may furthermore obtain confidence intervals associated with the predictions and/or prediction error. The ML inference module 412 may then output 810 the predicted QoS information, essentially, parameters.

FIG. 9 is a flowchart illustrating an example embodiment of a process that may be performed by a user interface described herein. The example process may be performed in association with a potential new customer for a wireless service accessing the service tool UI 120. In the example process, a user interface receives 902 a location where the potential customer desires service. The location may comprise, for example, a street address or a set of GPS coordinates—latitude, longitude, elevation. The service tool UI 120 application checks 904 the availability of service at the specified location and determines one or more QoS parameters for the location. For example, as will be further described below, the service tool UI 120 may access a database of deployed wireless and/or FWA assets in the area surrounding the location in order to determine the QoS parameters. Alternatively, or in addition, the service tool UI 120 may input the location to an ML model to predict one or more QoS parameters associated with the location. The service tool UI 120 may obtain specific values for various QoS parameters and/or may make a binary determination indicative of whether or not the QoS is acceptable 906. For example, the service tool UI 120 may compare one or more QoS parameters (or a function thereof) to one or more threshold values. If service with sufficient QoS is currently available at the specified location, the service tool UI 120 may recommend a service plan 908 that is expected to achieve the sufficient QoS and facilitate 910 a process for the prospective or potential new customer to enroll in the service plan. The user interface may receive a selection from the customer (to accept or decline the recommendation). If the service plan is acceptable, the user interface may present a digital contract to enable the potential customer to subscribe to the service, buy equipment, or other tasks. The user interface may optionally present additional information such as the types of wireless equipment supported, payment plan options, etc.

If the QoS is not acceptable 906, (e.g., service is not currently available at all, or is available but with poor QoS), then the service tool UI 120 may obtain predictions about future QoS at the location. For example, the service tool UI 120 may access a database that includes information about assets that are planned to be deployed in the area of the target location in order to predict future QoS 912. Here, prediction may furthermore involve application of one or more ML models trained to predict QoS parameters based on deployed assets. The user interface may then facilitate 914 a customer plan to encourage the customer to engage with the wireless service provider in the future. For example, the user interface may enable the customer to enroll in an email, SMS, and/or call list to alert the potential/interested customer when service becomes available. Additionally, the user interface may present a link that enables the potential/interested customer to recheck availability at a future date.

FIG. 10 illustrates another example embodiment of a process associated with the service tool UI 120. Here, the service tool UI 120 may be employed in a self-guided fashion by existing customers to assess the QoS they are currently getting at their address, understand if the service experience is per their subscribed plan and potentially upgrade service if available. The service tool UI 120 obtains 1002 customer information that includes a location of the customer. Here, the customer may directly input their address or may input login credentials that enables the service tool UI 120 to access a previously stored customer profile that includes location information. The service tool UI 120 may then check 1004 the QoS parameters associated with the customer's location in the same manner described above, and determine 1006 if the QoS parameters are at acceptable levels per the customer's subscribed service plan. Here, the threshold values for determining acceptability of QoS parameters may be based at least in part on the customer's specific plan since different plans may be associated with varying expected QoS levels. If the QoS is not meeting the expected level per the customer's subscribed plan, the service tool UI 120 may present 1012 information to the customer relating to expected service restoration to subscribed QoS levels by identifying issues to be fixed either at transmitting (wireless asset) or customer (receiver) end. For example, the service tool UI 120 may obtain and present information indicating a cause of the low QoS such as in-progress maintenance, equipment failures, or other factors. The service tool UI 120 may furthermore obtain and present information indicating an expected restoration timeline. In further embodiments, the service tool UI 120 may enable the customer to submit a service request to the service provider. If the QoS is deemed acceptable for the customer's subscription level, the user interface may facilitate 1008 presentations of information about potential service plan upgrades to achieve greater QoS. Here, upgrades may be available where additional and/or optimized assets in the customer's area are available and may be activated or reconfigured to enhance the customer's service under a higher-level subscription plan. The service tool UI 120 may then facilitate 1010 customer enrollment, such as execution of a contract or other steps to enable the existing customer to upgrade the plan.

The service tool UI 120 and processes described in FIGS. 9-10 may similarly be used by marketing, sales, and service team members of a wireless and/or FWA network provider to assist customers in evaluating QoS, fixing issues with subscribed service and potentially upgrading service. Depending upon the QoS assessed at the address, the team can recommend a subscriber plan (tier, payment options, equipment needed, etc.) and upon agreement with the customer, sign the contract. If the service is not available for a given address but will be available due to wireless and/or FWA assets planned for deployment in near future, the team can register the potential new customer to contact in future when the service becomes available. The service tool UI 120 may furthermore be used by support agents when customers seek assistance with restoring or upgrading service.

The described QoS prediction technique may be used in the service tool UI 120 associated with wireless and FWA network providers, specifically to predict QoS for their potential new customers or to assess QoS for their existing customers. The service tool UI 120 may be customized for a given wireless or FWA provider by considering all relevant parameters and features of their already deployed or planned network assets.

### Additional Considerations

Embodiments of the described system and corresponding processes may be implemented by one or more computing systems. The one or more computing systems include at least one processor and a non-transitory computer-readable storage medium storing instructions executable by the at least one processor for carrying out the processes and functions described herein. The computing system may include distributed network-based computing systems in which functions described herein are not necessarily executed on a single physical device. For example, some implementations may utilize cloud processing and storage technologies, virtual machines, or other technologies.

The foregoing description of the embodiments has been presented for the purpose of illustration; it is not intended to be exhaustive or to limit the embodiments to the precise form disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope is not limited by this detailed description, but rather by any claims that issue on an application based hereon.

1. A computer-implemented method for predicting one or more Quality of Service (QoS) parameters associated with a wireless network, the method comprising:
obtaining a target location for predicting the one or more QoS parameters;
determining characteristics of one or more wireless assets in a region associated with the target location;
obtaining geospatial features for the region associated with the target location;
applying a hybrid machine learning model to predict the one or more QoS parameters at the target location based on the characteristics of the one or more wireless assets and the geospatial features for the region, the hybrid machine learning model based in part on a physics based model that models wireless signal propagation of the wireless assets given the geospatial features, and the hybrid machine learning model based in part on a data driven model learned from historical measured operational data associated with the wireless network; and
outputting the one or more QoS parameters to a user interface.

2. The computer-implemented method of claim 1, wherein obtaining the target location comprises obtaining, from a user interface, at least one of: a set of geospatial coordinates, a street address, and a selected position in a map view.

3. The computer-implemented method of claim 1, wherein obtaining the geospatial features comprises:
obtaining satellite map image data from a map data source; and
processing the satellite map image data to identify one or more obstacles in the region that impact wireless signal propagation.

4. The computer-implemented method of claim 3, wherein processing the satellite map image data comprises:
applying a machine learning model trained to identify and characterize the one or more obstacles.

5. The computer-implemented method of claim 3, wherein identifying the one or more obstacles comprises identifying at least one of: a building, a tree, foliage, a manmade structure, and a geological feature.

6. The computer-implemented method of claim 1, wherein applying the hybrid machine learning model comprises:
responsive to a selection to perform a broad area analysis, predicting the QoS parameters over a broad prediction region including the target location at a first spatial resolution; and
responsive to a selection to perform a focused area analysis, predicting the QoS parameters over a focused prediction region including the target location at a second spatial resolution higher than the first spatial resolution.

7. The computer-implemented method of claim 1, wherein the region associated with the target location comprises a Fresnel zone representing an area around a line-of-sight of a receiver at the target location.

8. The computer-implemented method of claim 6, wherein the focused prediction region corresponds to a single property of an existing customer or prospective customer of the wireless network.

9. The computer-implemented method of claim 1, wherein outputting the one or more QoS parameters comprises:
generating a map overlay that represents different values of the one or more QoS parameters at different locations using a color-coding scheme.

10. The computer-implemented method of claim 1, further comprising:
dependent on the one or more QoS parameters predicted for the target location, generating a recommended subscription service associated with the wireless network;
presenting the recommended subscription service in the user interface; and
facilitating enrollment of an existing or prospective customer in the recommended subscription service.

11. The computer-implemented method of claim 1, further comprising:
performing a comparison of the one or more QoS parameters predicted for the target location to measured QoS parameters experienced by an existing customer;
identifying a subscriber service issue based on the comparison; and
facilitating resolution of the subscriber service issue for that customer.

12. The computer-implemented method of claim 1, wherein the one or more QoS parameters comprises at least one of: RSRP, SINR, download (D/L) speed, upload (U/L) speed.

13. A non-transitory computer-readable storage medium storing instructions for predictions one or more Quality of Service (QoS) parameters associated with a wireless network, the instructions when executed by one or more processors causing the one or more processors to perform steps including:
obtaining a target location for predicting the one or more QoS parameters;
determining characteristics of one or more wireless assets in a region associated with the target location;
obtaining geospatial features for the region associated with the target location;
applying a hybrid machine learning model to predict the one or more QoS parameters at the target location based on the characteristics of the one or more wireless assets and the geospatial features for the region, the hybrid machine learning model based in part on a physics based model that models wireless signal propagation of the wireless assets given the geospatial features, and the hybrid machine learning model based in part on a data driven model learned from historical measured operational data associated with the wireless network; and
outputting the one or more QoS parameters to a user interface.

14. The non-transitory computer-readable storage medium of claim 13, wherein obtaining the target location comprises obtaining, from a user interface, at least one of: a set of geospatial coordinates, a street address, and a selected position in a map view.

15. The non-transitory computer-readable storage medium of claim 13, wherein obtaining the geospatial features comprises:
obtaining satellite map image data from a map data source; and
processing the satellite map image data to identify one or more obstacles in the region that impact wireless signal propagation.

16. The non-transitory computer-readable storage medium of claim 15, wherein processing the satellite map image data comprises:
applying a machine learning model trained to identify and characterize the one or more obstacles.

17. The non-transitory computer-readable storage medium of claim 15, wherein identifying the one or more obstacles comprises identifying at least one of: a building, a tree, foliage, a manmade structure, and a geological feature.

18. The non-transitory computer-readable storage medium of claim 13, wherein applying the hybrid machine learning model comprises:
responsive to a selection to perform a broad area analysis, predicting the QoS parameters over a broad prediction region including the target location at a first spatial resolution; and
responsive to a selection to perform a focused area analysis, predicting the QoS parameters over a focused prediction region including the target location at a second spatial resolution higher than the first spatial resolution.

19. The non-transitory computer-readable storage medium of claim 13, wherein the region associated with the target location comprises a Fresnel zone representing an area around a line-of-sight of a receiver at the target location.

20. A computer system comprising:
one or more processors; and
a non-transitory computer-readable storage medium storing instructions for predicting one or more Quality of Service (QoS) parameters associated with a wireless network, the instructions when executed by the one or more processors causing the one or more processors to perform steps including:
obtaining a target location for predicting the one or more QoS parameters;
determining characteristics of one or more wireless assets in a region associated with the target location;
obtaining geospatial features for the region associated with the target location;
applying a hybrid machine learning model to predict the one or more QoS parameters at the target location based on the characteristics of the one or more wireless assets and the geospatial features for the region, the hybrid machine learning model based in part on a physics based model that models wireless signal propagation of the wireless assets given the geospatial features, and the hybrid machine learning model based in part on a data driven model learned from historical measured operational data associated with the wireless network; and
outputting the one or more QoS parameters to a user interface.
